(19) United States
(12) Patent Application Publication
(10) Pub. No.: US 2024/0065306 A1
(43) Pub. Date: Feb. 29, 2024

(54) SAUCE

(71) Applicant: UAB "DAUMANTAI LT", Kedainiu r (LT)

(72) Inventors: Saulius GRINKEVICIUS, Kedainiu r (LT); Galina GARMIENE, Kaunas (LT); Alvija ŠALAŠEVICIENE, Kaunas (LT)

(21) Appl. No.: 18/252,658

(22) PCT Filed: Oct. 29, 2021
(86) PCT No.: PCT/IB2021/060042

§ 371 Date: May 11, 2023

(30) Foreign Application Priority Data
Nov. 12, 2020 (LT) 2020041

(51) Int. Cl. A23L 33/16; A23L 27/60; A23L 19/00

(52) U.S. Cl. CPC A23L 33/16; A23L 27/63; A23L 19/09

(57) ABSTRACT

The invention belongs to the field of food industry: sauces, ketchups and toppings with tomatoes and products thereof. The sauce consists of tomatoes and their products, sugar, salt, herbs/spices and thickeners. The sauce is enriched with calcium and magnesium chemical compounds (usually calcium and magnesium or citrates, or lactates, carbonates or oxides thereof), their mixtures or aqueous solutions, which are easily absorbed by the human body.

The invention belongs to the food industry—namely the area of sauce production, i.e., sauces, ketchups, toppings, pastes, purees, spreads and dipping sauces with tomatoes and their products.

Calcium is the most common mineral in the human body. This mineral helps muscles to contract and so facilitates movement. Calcium also helps to transfer nerve impulses and maintains hormonal balance. However, the most important function of calcium is the maintenance of bone structure. The optimal daily rate of calcium for a person is 800 mg. One litre of milk, kefir or buttermilk contains about 1200 mg of calcium, 100 g of fermented cheese—about 600 mg of calcium. Over the years, the human body needs more and more calcium, so it is recommended that we consume calcium-enriched food products or dietary supplements. The World Health Organization (WHO) has found that in most European countries with the food, there is an under-consumption of magnesium—it is especially not enough for older people and young women. Magnesium maintains heart rhythm and muscle relaxation and normalises blood pressure. If there is a lack of magnesium, its concentration is restored by adjusting the diet, or it is recommended to take dietary supplements containing magnesium salts. According to the dietary norms of WHO, it is recommended that a person consumes 350-400 mg of magnesium daily with food. Organic magnesium salts have been found to be more soluble and better absorbed than magnesium oxide.

Following the assessment of the importance of these various elements for the human body, food products and beverages are enriched with minerals by adding calcium (Ca) and magnesium (Mg) salts.

Industrially made tomato products (tomato sauces, ketchups) are widely used in recipes of various dishes and are popular throughout the world all year round, so they can be used to enrich human nutrition with calcium and magnesium, and other trace elements. Tomatoes (Latin Solanum lycopersicum) are a valuable fruit which contain organic substances useful for the human body (e.g. lycopene), containing significant amounts of vitamin C, phytoelements characterised with an anti-cancer effect, macronutrients (calcium, potassium, magnesium, iron salts), trace elements, carotene (provitamin A) and vitamins B1, B2, P, PP and K.

There is a known technical solution: ‘Method for the production of calcium-enriched food additive from eggshells’ (JPH0411866, A23L1/304). The calcium-enriched food additive is produced from powdered eggshells by exposing it to a solution of organic acid (lactic, citric, malic or tartaric acid). The disadvantage of this method is the need to carry out the following technological operations: grind the eggshells, dose with the components, perform the reaction, remove the emitted carbon dioxide gas, filter, and perform composition analysis of the resulting solution.

There is a known technical solution: ‘Water, juice, beverages and other liquid foods enriched with calcium or calcium-magnesium complex’ (U.S. Pat. No. 6,261,610; EP1217904; WO01/22838, A23L1/304). The complex of calcium and calcium-magnesium is made from calcium oxide or calcium hydroxide, calcium carbonate and/or magnesium hydroxide or magnesium oxide, or their mixture, and an aqueous solution of a mixture of lactic and citric acids. The complex is stabilised by carbohydrates: sucrose, fructose, glucose, corn syrup, maltodextrins, oligo- and polysaccharides. The products enriched with this complex are transparent and no foreign taste is detected in them. The disadvantage of this method is the need to carry out the following technological operations: dosing with calcium and magnesium alkaline components, dosing with acids, adjusting the calcium-magnesium ratio in the complex produced, removing emitted gases, filtering, and performing the composition analysis of the resulting solution.

The closest known technical solution is ‘Tomato ketchup’ (KR960015878, A23L27/60), where the ketchup is enriched with calcium as follows: ground eggshell powder is added to a 10% solution of acid or food vinegar; the solution is mixed until the powder is dissolved, then filtered. The prepared solution is added to the ketchup so that 100 g of sauce contains 430-450 mg of calcium. The disadvantage of this method is the need to carry out the following technological operations: dosing with vinegar, grinding eggshells, removing emitted carbon dioxide gas and filtering the solution.

The objective of the invention to be patented is the provision to various groups of the population of calcium and magnesium macronutrients by producing tomato sauces enriched with such elements.

The sauce to be patented consists of water, heat-treated tomatoes and/or products thereof, thickeners, sweeteners, acidity regulators, table salt, herbs/spices and vegetables and this sauce is enriched with water-soluble or calcium, or magnesium chemical compounds, or a mixture of these, so the result is optionally composed of (percentage by mass):
tomatoes and/or products thereof 5-90,
thickeners 0-10,
sugar or sweeteners 0-25,
acids and/or acidity regulators 0.5-15,
table salt (NaCl) 0.4-4,
herbs/spices 0-5,
vegetables and/or fruits 0-25,
preservatives 0-0.2,
calcium chemical compounds 0-4,
magnesium chemical compounds 0-2,
aqueous solution of calcium and magnesium chemical compounds 0-20,
water up to 100,
and this sauce has a dry matter content of 10% to 40%, of which dry matter of tomatoes content of 5% to 20%, a calcium element (Ca) from 0.12% to 0.8% and a magnesium element (Mg) from 0.05% to 0.4%.

The sauce to be patented is enriched with or calcium carbonate, or calcium chloride, or calcium salts of citric acid, or calcium gluconate, or calcium glycerophosphate, or calcium lactate, or calcium salts of orthophosphoric acid, or calcium hydroxide, or calcium malate, or calcium oxide, or calcium sulphate, or magnesium acetate, or magnesium carbonate, or magnesium chloride, or magnesium salts of citric acid, or magnesium gluconate, or magnesium glycerophosphate, or magnesium salts of orthophosphoric acid, or magnesium lactate, or magnesium hydroxide, or magnesium oxide, or magnesium potassium citrate, or magnesium sulphate, or a mixture of the various calcium and magnesium chemicals listed, or an aqueous solution of that mixture.

The sauce to be patented is enriched with or one, or more calcium chemical compounds.

The sauce to be patented is enriched with or one, or more magnesium chemical compounds.

The sauce to be patented is enriched, preferably with calcium or magnesium or citrates, or lactates, or carbonates.

The sauce to be patented is enriched, preferably with calcium lactate from 0.5% to 3.3% and citric acid magnesium salts (magnesium citrates) from 0.2% to 1.3%, or a mixture thereof from 0.7% to 4.6%, or an aqueous solution thereof from 5% to 20% by mass.

The sauce or ketchup may consist of different raw materials or ingredients, the names and forms of which are given in the table below.

| | Raw materials or components of the |
|---|---|
| Name of the ingredient of the | ingredient optionally according to the |
| sauce or ketchup | recipe |
| Tomatoes and/or products | Or natural, or paste, or diced, or puree, |
| thereof | or juice tomatoes; dried or sun-dried |
| | tomatoes |
| Thickeners | Starches (potatoes, maize, tapioca, wheat |
| | or rice); modified starches (E1442, |
| | E1414); guar gum, xanthan gum, locust |
| | bean gum, pectin |
| Sugar and sweeteners | Sucrose, fructose, glucose or syrup from |
| | mixtures thereof, xylitol, aspartame, stevia |
| Acids and/or acidity regulators | Vinegar, citric, lactic, malic acids; lemon |
| | juice or concentrate thereof; ethyl spirit, |
| | grape wine, apple wine or fruit wine |
| | vinegar |
| Table salt (NaCI) | Pure-dried vacuum, iodised, sea salt or |
| | solutions thereof |
| Herbs/spices | Allspice, black, white, cayenne pepper; |
| | bay leaves, ginger, basil, oregano, |
| | tarragon, dill, coriander, cloves, parsley, |
| | chilli powder, cinnamon, turmeric, curry |
| | or mixtures thereof |
| Vegetables and fruits | Onions, garlic, carrots, parsnips, celery, |
| | sweet and chilli peppers; pineapples, |
| | apples, pears, plums or natural, ground, |
| | dried juices, puree or pastes or mixtures |
| | thereof |
| Preservatives | Sodium benzoate, potassium sorbate |

The authors of the invention found that tomato sauces currently being sold on the market are low in calcium (about 20-50 mg/100 g) and low in magnesium (about 8-16 mg/100 g of the product), so it is appropriate to enrich these products by adding Ca and Mg chemical compounds. It is important to select the salts of the well-assimilated Ca and Mg. The uptake of salts with residues of organic acids has been found to be better and based on this information, more extensive research has been carried out on calcium lactate as a source of calcium, and magnesium citrate as a source of magnesium.

The added calcium lactate content is calculated so that the calcium content per 100 g of the sauce amounts to 15% of the reference nutritional value (RNV). For humans the daily RNV of calcium is 800 mg, corresponding to a 15% RNV of 120 mg/100 g. For calcium lactate with the formula C₆H₁₀CaO₆*5H₂O, it has been calculated that about 0.9% by mass is to be added.

The added magnesium citrate content is calculated so that the magnesium content in the product would amount to 15% RNV. The recommended intake of magnesium per day is 375 mg, corresponding to a 15% RNV of 56.25 mg/100 g. For citric acid magnesium salt (magnesium citrate) with the formula C₁₂H₁₀Mg₃O₁₄*9H₂O, it has been calculated that about 0.5% by mass is to be added.

Examples of sauce production are given below.

### EXAMPLE 1

100 kg of tomato sauce is produced as follows:
the cooking boiler is filled with 40 l of water, heating and mixing are activated; 40 kg (30% of dry matter) of tomato paste is added to the water, followed by 7 kg of sugar and 1 kg of iodised salt (NaCl);
another container is filled with 10 l of water, 0.9 kg of calcium lactate with formula C₆H₁₀CaO₆*5H₂O and 0.5 kg of magnesium citrate with formula C₁₂H₁₀Mg₃O₁₄*9H₂O, followed by a mixture of 5 kg of sugar and 0.5 kg of ground spices (black and allspice, cloves, coriander);
the ingredients are mixed in the container until blended, and added to the cooking boiler;
as soon as the temperature of 70° C. is reached, ethyl spirit vinegar, wine vinegar and lemon juice concentrate are added;
the sauce in the cooking boiler is heated to 85° C., then the remaining water (about 8-12 l) is added so the amount of sauce at the end of cooking is 100 kg.

This sauce contains 29.5% dry matter, of which 12% is tomato dry matter, 0.04% natural calcium and 0.01% natural magnesium, with added 0.12% calcium and magne-sium. Total calcium content 0.16%, magnesium content 0.06%.

### EXAMPLE 2

100 kg of ketchup is produced as follows:
the cooking boiler is filled with 50 l of water, heating and mixing are activated; 32 kg (24% of dry matter) of tomato puree is added, followed by 8 kg of sugar and 2 kg of iodised salt (NaCl);
another container is filled with 10 l of water, 0.6 kg of tricalcium citrate with formula Ca₃(C₆H₅O₇)₂, and 0.5 kg of magnesium citrate with formula C₁₂H₁₀Mg₃O₁₄*9H₂O, followed by a mixture of 5 kg of sugar and 0.4 kg of ground spices (black and allspice, cloves, coriander);
the ingredients are mixed in the container until blended, and added into the cooking boiler;
as soon as the temperature of 70° C. is reached, the ethyl spirit and wine vinegar with the pH of the active acidity (3.8±0.1) is added;
the sauce in the cooking boiler is heated to 85° C., then the remaining water (about 9-14 l) is added so the amount of sauce at the end of cooking is 100 kg.

The prepared sauce contains 25% dry matter, of which 7.7% is tomato dry matter, natural calcium and 0.01% natural magnesium, with added 0.145% calcium and 0.05% magnesium. The total amount of calcium is 145 mg; magnesium contains 60 mg per 100 g of ketchup.

### EXAMPLE 3

100 kg of ketchup is produced as follows:
the cooking boiler is filled with 50 l of water, heating and mixing are activated; 32 kg (24% of dry matter) of tomato puree is added, followed by 8 kg of sugar and 2 kg of iodised salt (NaCl);
another container is filled with 10 l of water and 1.2 kg of tricalcium citrate with formula Ca₃(C₆H₅O₇)₂, followed by a mixture of 5 kg of sugar and 0.4 kg of ground spices (black and allspice, cloves, coriander);
the ingredients are mixed in the container until blended and added to the cooking boiler;
as soon as the temperature of 70° C. is reached, the ethyl spirit vinegar and the citric acid solution with the pH of the active acidity (3.8±0.2) are added;
the sauce in the cooking boiler is heated to 85° C., and the remaining water (about 9-14 l) is added so the amount of sauce at the end of cooking is 100 kg.

The prepared sauce contains 25% dry matter, of which 7.7% is tomato dry matter, natural calcium and 0.01% natural magnesium, with added 0.289% calcium. The total content of calcium is 329 mg per 100 g of ketchup.

### EXAMPLE 4

100 kg of tomato sauce is produced as follows:
the cooking boiler is filled with 25 l of water, heating and mixing are activated; 15 kg of tomato paste (28% dry matter), 5 kg of dried tomato powder (80% dry matter) and 20 kg of tomato juice (6% dry matter) is added, followed by 7 kg of sugar and 2 kg of iodised salt (NaCl);
another container is filled with 5 l of water, 0.17 kg of calcium oxide (CaO) and 0.17 kg of magnesium carbonate (MgCO₃) followed by 0.94 kg of citric acid, and the solution is mixed until the substances dissolve. Then 5 l of water, 5 kg of sugar, 2 kg of oxidised starch (E1404) and a mixture of 0.5 kg of ground spices (black and allspice, cloves, coriander) are added;
the ingredients are mixed in the container until blended, and poured into the cooking boiler;
as soon as the temperature of 70° C. is reached, the ethyl spirit vinegar with the pH of the active acidity (3.8+0.1) is added;
the sauce in the cooking boiler is heated to 85° C., and the remaining water (about 6-12 l) is added so the amount of sauce at the end of cooking is 100 kg.

The prepared sauce contains 27.3% dry matter, of which 9.4% is tomato dry matter, 0.04% natural calcium and 0.01% natural magnesium, with added 0.12% calcium and 0.049% magnesium. Total calcium content is 0.16%, and total magnesium content is 0.05%.

The novelty of the composition of the sauces to be patented is that they are enriched with calcium and magnesium by adding water-soluble chemical compounds of calcium and/or magnesium. The sauces, ketchups, toppings, pastes, purees, spreads and dipping sauces with tomatoes and their products to be patented are made according to various recipes according to consumer and market preferences, purpose, sensory indicators (e.g. flavour and consistency), nutritional value and available raw materials, but the information to consumers about their composition will indicate that additional substances with calcium or magnesium are added.

The essence of the patent—a sauce containing tomatoes enriched with calcium or magnesium—is not denied or altered by the addition of other chemical compounds, vitamins or other supplements not listed in the description of the patent.

Comparative analyses of the chemical composition of existing and sauces to be patented, microbiological indicators and sensory indicators have been carried out in production and laboratory conditions. Tomato sauces and ketchups to be patented with added calcium and magnesium organic acid salts with content amounting to 15% of the nutrient reference value were found to have similar chemical composition, microbiological indicators and sensory indicators as comparable (control) samples. The sauces enriched with calcium and magnesium benefit consumers since their nutritional value is improved.

1. A sauce consisting of: water, heat-treated tomatoes and/or products thereof, thickeners, sweeteners, acidity regulators, table salt, herbs/spices and vegetables, wherein the sauce is enriched with additionally added water-soluble or calcium, or magnesium chemical compounds, or a mixture of these, such that the sauce is composed of (percentage by mass):
tomatoes and/or products thereof 5-90,
thickeners 0-10,
sugar or sweeteners 0-25,
acids and/or acidity regulators 0.5-15,
table salt (NaCl) 0.4-4,
herbs/spices 0-5,
vegetables and/or fruits 0-25,
preservatives 0-0.2,
calcium chemical compounds 0-4,
magnesium chemical compounds 0-2,
aqueous solution of calcium and magnesium chemical compounds 0-20,
water up to 100 and the sauce has a dry matter content of 10% to 40%, of which dry matter of tomatoes of 5% to 20%, an additionally added calcium element (Ca) from 0.12% to 0.8% and an additionally added magnesium element (Mg) from 0.05% to 0.4%.

2. The sauce according to claim 1, wherein the sauce is further enriched with: calcium chloride, calcium salts of citric acid, calcium glycerophosphate, calcium lactate, calcium salts of orthophosphoric acid, calcium hydroxide, calcium malate, calcium oxide, magnesium acetate, magnesium chloride, magnesium salts of citric acid, magnesium gluconate, magnesium glycerophosphate, magnesium salts of orthophosphoric acid, magnesium lactate, magnesium hydroxide, or magnesium oxide, magnesium potassium citrate, magnesium sulphate, a mixture of the various calcium and magnesium chemicals listed, or an aqueous solution of that mixture.

3. (canceled)

4. (canceled)

5. The sauce according to claim 1, wherein the sauce is further enriched with calcium and magnesium, citrates, or lactates.

6. The sauce according to claim 1, wherein the sauce is enriched with calcium lactate from 0.5% to 3.3% and citric acid magnesium salts (magnesium citrates) from 0.2% to 1.3% by mass, or a mixture thereof.

7. The sauce according to claim 2, wherein the sauce is enriched with calcium lactate from 0.5% to 3.3% and magnesium salts of citric acid (magnesium citrates) from 0.2% to 1.3% by mass, or a mixture thereof.
